(19) United States
(12) Patent Application Publication
(10) Pub. No.: US 2025/0095321 A1
(43) Pub. Date: Mar. 20, 2025

(54) EQUIPMENT OPERATION DEVICE AND EQUIPMENT OPERATION METHOD

(71) Applicant: Mitsubishi Electric Corporation, Tokyo (JP)

(72) Inventor: Takashi OGAWA, Tokyo (JP)

(73) Assignee: Mitsubishi Electric Corporation, Tokyo (JP)

(21) Appl. No.: 18/961,596

(22) Filed: Nov. 27, 2024

Related U.S. Application Data
(63) Continuation of application No. PCT/JP2022/023228, filed on Jun. 9, 2022.

(51) Int. Cl. G06V 10/25; G06T 5/50; G06V 10/74

(52) U.S. Cl. CPC G06V 10/25; G06T 5/50; G06V 10/761; G06T 2207/20221

(57) ABSTRACT

An equipment operation device includes processing circuitry is configured to; acquire, from a camera, image data indicating a captured image in which operation target equipment and a peripheral region of the operation target equipment appear; perform a process of detecting a difference between the captured image indicated by the acquired image data and a first registered image that has been recorded; record the captured image as a second registered image that is different from the first registered image when the difference is detected, and acquire a second captured image differentiated from the first registered image that has been recorded and to record the second captured image as the second registered image that is different from the first registered image when the difference is not detected; and download an operation application of the operation target equipment appearing in the second registered image having been recorded.

### CROSS-REFERENCE TO RELATED APPLICATION

This application is a Continuation of International Patent Application No. PCT/JP2022/023228, filed on Jun. 9, 2022, the entire contents of which are incorporated herein by reference.

### TECHNICAL FIELD

The present disclosure relates to an equipment operation device and an equipment operation method.

### BACKGROUND ART

There is an equipment operation device that receives an operation of operation target equipment by executing an operation application of the operation target equipment (See, for example, Patent Literature 1).

The equipment operation device includes a first peripheral image acquiring unit, a second peripheral image acquiring unit, a setting unit, and a signal output unit. The first peripheral image acquiring unit acquires first peripheral images that are images of respective peripheral regions in one or more pieces of operation target equipment, and stores the respective first peripheral images in association with the pieces of operation target equipment. The second peripheral image acquiring unit acquires a second peripheral image that is an image of a peripheral region of operation target equipment, captured when a user operates the operation target equipment. When there is a first peripheral image coincident with the second peripheral image among the plurality of first peripheral images, the setting unit sets a piece of operation target equipment corresponding to the first peripheral image as a piece of equipment to be actually operated. When there is no first peripheral image coincident with the second peripheral image among the plurality of first peripheral images, the setting unit receives an operation of selecting a piece of equipment to be actually operated by a user. The signal output unit outputs an operation signal to a piece of equipment to be actually operated by executing an operation application of the piece of equipment.

### CITATION LIST

### Patent Literature

Patent Literature 1: JP 2012-119935 A

### SUMMARY OF INVENTION

### Technical Problem

For example, in an individual's house, a plurality of rooms having the same shape and having the same pattern of a ceiling, a floor, or a wall may be present. In each of a plurality of rooms having the same pattern or the like of a wall, for example, an air conditioner of the same model may be disposed as operation target equipment.

In such a case, since peripheral regions of the air conditioners disposed in the plurality of rooms are similar to each other, it may be difficult to distinguish images of the peripheral regions of the air conditioners disposed in the rooms from each other.

In the equipment operation device disclosed in Patent Literature 1, since the first peripheral images of the pieces of operation target equipment disposed in the plurality of rooms are similar to each other, the first peripheral image acquiring unit may store the plurality of respective first peripheral images similar to each other in association with the pieces of operation target equipment. In such a case, the setting unit may fail to detect a first peripheral image coincident with the second peripheral image among the plurality of first peripheral images, or may erroneously detect a first peripheral image not coincident with the second peripheral image. In addition, also for a user, it may be difficult to determine which piece of operation target equipment among pieces of operation target equipment associated with the respective first peripheral images is a piece of equipment to be actually operated. Under these circumstances, there is a problem that the signal output unit cannot execute an operation application of a piece of equipment to be actually operated in some cases.

The present disclosure has been made in order to solve the above problem, and an object of the present disclosure is to provide an equipment operation device and an equipment operation method capable of executing an operation application of operation target equipment appearing in a captured image even in a case where the captured image and a registered image that has been recorded are similar to each other, and a difference between these images is not detected.

### Solution to Problem

An equipment operation device according to the present disclosure includes processing circuitry configured to; acquire, from a camera, image data indicating a captured image in which operation target equipment and a peripheral region of the operation target equipment appear; perform a process of detecting a difference between the captured image indicated by the acquired image data and a first registered image that has been recorded; record the captured image as a second registered image that is different from the first registered image when the difference is detected, and acquire a second captured image differentiated from the first registered image that has been recorded and to record the second captured image as the second registered image that is different from the first registered image when the difference is not detected; and download an operation application of the operation target equipment appearing in the second registered image having been recorded.

### Advantageous Effects of Invention

According to the present disclosure, it is possible to execute an operation application of operation target equipment appearing in a captured image even in a case where the captured image and a registered image that has been recorded are similar to each other, and a difference between these images is not detected.

### BRIEF DESCRIPTION OF DRAWINGS

FIG. 1 is a configuration diagram illustrating an equipment operation device 3 according to a first embodiment.

FIG. 2 is a hardware configuration diagram illustrating hardware of the equipment operation device 3 according to the first embodiment.

FIG. 3 is a hardware configuration diagram of a computer in a case where the equipment operation device 3 is implemented by software, firmware, or the like.

FIG. 4 is a flowchart illustrating an equipment operation method which is a processing procedure performed by the equipment operation device 3.

FIG. 5 is an explanatory diagram illustrating a captured image in which operation target equipment 1 and a peripheral region of the operation target equipment 1 appear.

FIG. 6 is an explanatory diagram illustrating an example of an identification marker.

FIG. 7 is an explanatory diagram illustrating a display example of one or more operation applications downloaded by a download unit 15.

FIG. 8 is a configuration diagram illustrating an equipment operation device 3 according to a second embodiment.

FIG. 9 is a hardware configuration diagram illustrating hardware of the equipment operation device 3 according to the second embodiment.

FIG. 10 is a configuration diagram illustrating an equipment operation device 3 according to a third embodiment.

FIG. 11 is a hardware configuration diagram illustrating hardware of the equipment operation device 3 according to the third embodiment.

FIG. 12A is an explanatory diagram illustrating an example of a captured image PG without a grid, and FIG. 12B is an explanatory diagram illustrating an example of a captured image PG_{G} with a grid.

FIG. 13 is a configuration diagram illustrating an equipment operation device 3 according to a fourth embodiment.

FIG. 14 is a hardware configuration diagram illustrating hardware of the equipment operation device 3 according to the fourth embodiment.

FIG. 15 is an explanatory diagram illustrating an example of a feature region FRₘ.

### DESCRIPTION OF EMBODIMENTS

Hereinafter, in order to describe the present disclosure in more detail, embodiments for carrying out the present disclosure will be described with reference to the attached drawings.

### First Embodiment

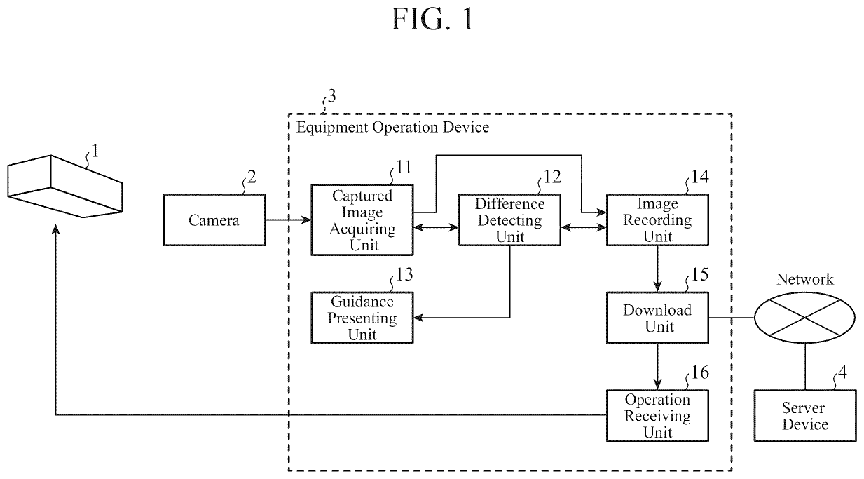

FIG. 1 is a configuration diagram illustrating an equipment operation device 3 according to a first embodiment.

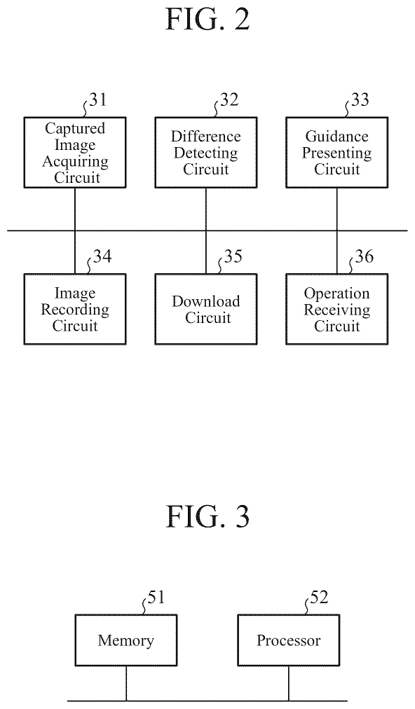

FIG. 2 is a hardware configuration diagram illustrating hardware of the equipment operation device 3 according to the first embodiment.

In FIG. 1, operation target equipment 1 is, for example, an air conditioner, a television, or audio equipment. Here, for convenience of description, it is assumed that the operation target equipment 1 is an air conditioner.

A camera 2 captures an image of a range including the operation target equipment 1 and a peripheral region of the operation target equipment 1, and outputs image data indicating a captured image PG to the equipment operation device 3. The captured image PG may be a still image or a moving image.

In the equipment operation device 3 illustrated in FIG. 1, the camera 2 is disposed outside the equipment operation device 3. However, this is merely an example, and the camera 2 may be built in the equipment operation device 3.

The equipment operation device 3 includes a captured image acquiring unit 11, a difference detecting unit 12, a guidance presenting unit 13, an image recording unit 14, a download unit 15, and an operation receiving unit 16.

The captured image acquiring unit 11 is implemented by, for example, a captured image acquiring circuit 31 illustrated in FIG. 2.

The captured image acquiring unit 11 acquires image data indicating the captured image PG from the camera 2.

In addition, when a difference between the captured image PG and each of registered images RG₁ to RG_{N} that have been recorded is not detected by the difference detecting unit 12, the captured image acquiring unit 11 acquires, as a second captured image PG′, image data indicating a captured image in which the operation target equipment 1 to which an identification marker is pasted and a peripheral region of the operation target equipment 1 appear from the camera 2 after guidance is presented by the guidance presenting unit 13. N is an integer equal to or more than 1.

The captured image acquiring unit 11 outputs the image data indicating the captured image PG to each of the difference detecting unit 12 and the image recording unit 14.

The captured image acquiring unit 11 outputs image data indicating the second captured image PG′ to the image recording unit 14.

The difference detecting unit 12 is implemented by, for example, a difference detecting circuit 32 illustrated in FIG. 2.

The difference detecting unit 12 acquires image data indicating the captured image PG from the captured image acquiring unit 11, and acquires image data indicating a registered image RGₙ (n=1, . . . , N) that has been recorded from the image recording unit 14.

The difference detecting unit 12 performs a process of detecting a difference between the captured image PG and the registered image RGₙ that has been recorded. The process of detecting the difference is a process of comparing the captured image PG with the registered image RGₙ that has been recorded and determining whether or not there is a difference between these images.

The guidance presenting unit 13 is implemented by, for example, a guidance presenting circuit 33 illustrated in FIG. 2.

When the difference is not detected by the difference detecting unit 12, the guidance presenting unit 13 presents guidance that prompts a user to paste an identification marker.

As a method for presenting the guidance, the guidance presenting unit 13 may display the guidance on a display (not illustrated) or may output the guidance by voice from a speaker (not illustrated).

The image recording unit 14 is implemented by, for example, an image recording circuit 34 illustrated in FIG. 2.

When the difference is detected by the difference detecting unit 12, the image recording unit 14 acquires image data indicating the captured image PG from the captured image acquiring unit 11.

The image recording unit 14 records the captured image PG as a registered image RGₙ₊₁ (n=1, . . . , N).

When the difference is not detected by the difference detecting unit 12, the image recording unit 14 acquires image data indicating the second captured image PG′ differentiated from the registered image RG₁ that has been recorded from the captured image acquiring unit 11.

The image recording unit 14 records the second captured image PG′ as the registered image RGₙ₊₁.

That is, when the difference is not detected by the difference detecting unit 12, the image recording unit 14 acquires, as the second captured image PG′, a captured image in which the operation target equipment 1 to which an identification marker is pasted and a peripheral region of the operation target equipment 1 appear, and records the captured image as the registered image RGₙ₊₁.

The download unit 15 is implemented by, for example, a download circuit 35 illustrated in FIG. 2.

For example, the download unit 15 downloads an operation application of the operation target equipment 1 appearing in the registered image RGₙ₊₁ that has been recorded by the image recording unit 14 from a server device 4 of a manufacturer of the operation target equipment 1 via a network.

The operation application of the operation target equipment 1 is stored in, for example, an internal memory of the download unit 15.

The operation receiving unit 16 is implemented by, for example, an operation receiving circuit 36 illustrated in FIG. 2.

The operation receiving unit 16 receives selection of any one operation application from among one or more operation applications downloaded by the download unit 15.

The operation receiving unit 16 receives an operation of the operation target equipment 1 by executing an operation application selected by a user.

In FIG. 1, it is assumed that each of the captured image acquiring unit 11, the difference detecting unit 12, the guidance presenting unit 13, the image recording unit 14, the download unit 15, and the operation receiving unit 16, which are constituent elements of the equipment operation device 3, is implemented by dedicated hardware as illustrated in FIG. 2. That is, it is assumed that the equipment operation device 3 is implemented by the captured image acquiring circuit 31, the difference detecting circuit 32, the guidance presenting circuit 33, the image recording circuit 34, the download circuit 35, and the operation receiving circuit 36.

To each of the captured image acquiring circuit 31, the difference detecting circuit 32, the guidance presenting circuit 33, the image recording circuit 34, the download circuit 35, and the operation receiving circuit 36, for example, a single circuit, a composite circuit, a programmed processor, a parallel-programmed processor, an application specific integrated circuit (ASIC), a field-programmable gate array (FPGA), or a combination thereof corresponds.

The constituent elements of the equipment operation device 3 are not limited to those implemented by dedicated hardware, and the equipment operation device 3 may be implemented by software, firmware, or a combination of software and firmware.

Software or firmware is stored as a program in a memory of a computer. The computer means hardware that executes a program. To the computer, for example, a central processing unit (CPU), a central processing device, a processing device, an arithmetic device, a microprocessor, a microcomputer, a processor, or a digital signal processor (DSP) corresponds.

FIG. 3 is a hardware configuration diagram of a computer in a case where the equipment operation device 3 is implemented by software, firmware, or the like.

In a case where the equipment operation device 3 is implemented by software, firmware, or the like, a program for causing a computer to execute processing procedures in each of the captured image acquiring unit 11, the difference detecting unit 12, the guidance presenting unit 13, the image recording unit 14, the download unit 15, and the operation receiving unit 16 is stored in a memory 51. A processor 52 of the computer executes the program stored in the memory 51.

FIG. 2 illustrates an example in which each of the constituent elements of the equipment operation device 3 is implemented by dedicated hardware, and FIG. 3 illustrates an example in which the equipment operation device 3 is implemented by software, firmware, or the like. However, this is merely an example, and some of the constituent elements of the equipment operation device 3 may be implemented by dedicated hardware, and the remaining constituent elements may be implemented by software, firmware, or the like.

Next, an operation of the equipment operation device 3 illustrated in FIG. 1 will be described.

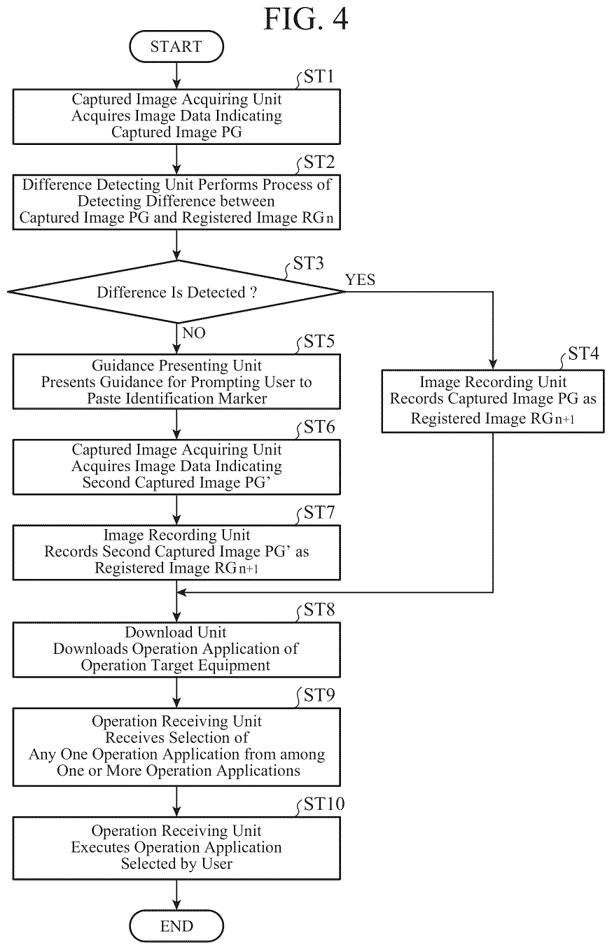

FIG. 4 is a flowchart illustrating an equipment operation method which is a processing procedure performed by the equipment operation device 3.

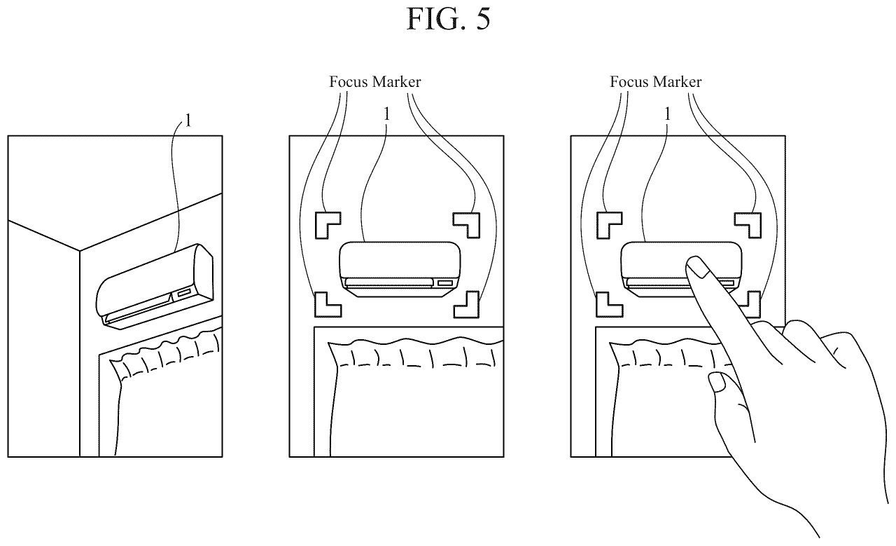

By operating the camera 2, a user captures an image of a range including the operation target equipment 1 and a peripheral region of the operation target equipment 1 as illustrated in FIG. 5.

FIG. 5 is an explanatory diagram illustrating a captured image in which the operation target equipment 1 and a peripheral region of the operation target equipment 1 appear.

In the example of FIG. 5, the peripheral region of the operation target equipment 1 includes a wall on which the operation target equipment 1 is disposed, a curtain disposed near the operation target equipment 1, and a ceiling near the wall on which the operation target equipment 1 is disposed.

In the example of FIG. 5, when the operation target equipment 1 is recognized by the camera 2, a focus marker is displayed on a finder of the camera 2.

When the user taps the operation target equipment 1 recognized by the camera 2, the operation target equipment 1 is determined.

The camera 2 captures an image of a range including the operation target equipment 1 and a peripheral region of the operation target equipment 1, and outputs image data indicating a captured image PG to the equipment operation device 3.

The captured image acquiring unit 11 acquires image data indicating the captured image PG from the camera 2 (step ST1 in FIG. 4).

The captured image acquiring unit 11 outputs the image data indicating the captured image PG to each of the difference detecting unit 12 and the image recording unit 14.

The difference detecting unit 12 acquires image data indicating the captured image PG from the captured image acquiring unit 11, and acquires image data indicating registered images RG₁ to RG_{N} that have been recorded from the image recording unit 14.

By comparing the captured image PG with the registered image RG₁ (n=1, . . . N) that has been recorded, the difference detecting unit 12 performs a process of detecting a difference between the captured image PG and the registered image RG₁ that has been recorded (step ST2 in FIG. 4).

As the process of detecting the difference, a known image comparing application that determines whether or not a plurality of images are the same image can be used. Examples of the known image comparing application include an application using a pattern matching method.

Specifically, the difference detecting unit 12 determines a similarity between the captured image PG and the registered image RG₁ that has been recorded. When the similarity is equal to or more than a threshold, the difference detecting unit 12 determines that there is “no difference” between the captured image PG and the registered image RGₙ. When the similarity is less than the threshold, the difference detecting unit 12 determines that there is a “difference” between the captured image PG and the registered image RGₙ. The threshold for determining the similarity may be stored in an internal memory of the difference detecting unit 12 or may be given from the outside of the equipment operation device 3.

The difference detecting unit 12 outputs a result of the process of detecting the difference to each of the captured image acquiring unit 11, the guidance presenting unit 13, and the image recording unit 14.

The image recording unit 14 acquires the result of the process of detecting the difference from the difference detecting unit 12.

If the difference is detected by the difference detecting unit 12 (step ST3 in FIG. 4: YES), the image recording unit 14 records the captured image PG as the registered image RGₙ₊₁ (step ST4 in FIG. 4).

The guidance presenting unit 13 acquires the result of the process of detecting the difference from the difference detecting unit 12.

If the difference is not detected by the difference detecting unit 12 (step ST3 in FIG. 4: NO), the guidance presenting unit 13 presents guidance that prompts a user to paste an identification marker (step ST5 in FIG. 4).

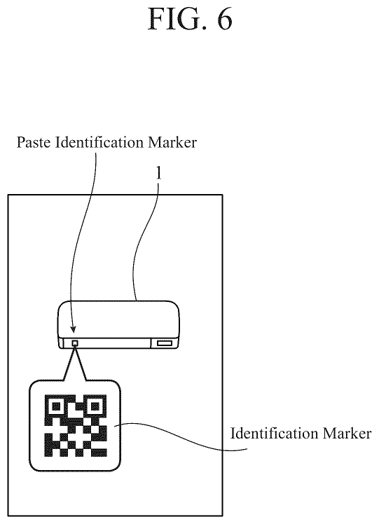

As illustrated in FIG. 6, the user to whom the guidance has been presented performs work of pasting the identification marker to the operation target equipment 1.

FIG. 6 is an explanatory diagram illustrating an example of the identification marker.

The identification marker may be a mark of any picture. For example, the identification marker may be packed in a cardboard in which the purchased operation target equipment 1 is packed.

When the captured image PG has already been recorded as the registered image RGₙ, the user to whom the guidance has been presented does not perform the operation of pasting the identification marker to the operation target equipment 1 in order to prevent double registration of the captured image PG.

In a case where the user performs the operation of pasting the identification marker to the operation target equipment 1, by operating the camera 2, the user captures an image of a range including the operation target equipment 1 to which the identification marker is pasted and a peripheral region of the operation target equipment 1.

The camera 2 outputs image data indicating the second captured image PG′ to the equipment operation device 3 with an image in which the operation target equipment 1 to which the identification marker is pasted and a peripheral region of the operation target equipment 1 appear as the second captured image PG′.

The captured image acquiring unit 11 acquires the result of the process of detecting the difference from the difference detecting unit 12.

When the difference is not detected by the difference detecting unit 12, the captured image acquiring unit 11 acquires the image data indicating the second captured image PG′ output from the camera 2 after the guidance is presented by the guidance presenting unit 13 (step ST6 in FIG. 4).

The captured image acquiring unit 11 outputs the image data indicating the second captured image PG′ to the image recording unit 14.

When the difference is not detected by the difference detecting unit 12, the image recording unit 14 acquires the image data indicating the second captured image PG′ from the captured image acquiring unit 11.

The image recording unit 14 records the second captured image PG′ as the registered image RGₙ₊₁ (step ST7 in FIG. 4).

When the captured image PG or the second captured image PG′ is recorded as the registered image RGₙ₊₁ by the image recording unit 14, the download unit 15 downloads an operation application of the operation target equipment 1 appearing in the registered image RG₁+, for example, from the server device 4 of the manufacturer of the operation target equipment 1 (step ST8 in FIG. 4).

The operation application of the operation target equipment 1 is stored in, for example, an internal memory of the download unit 15.

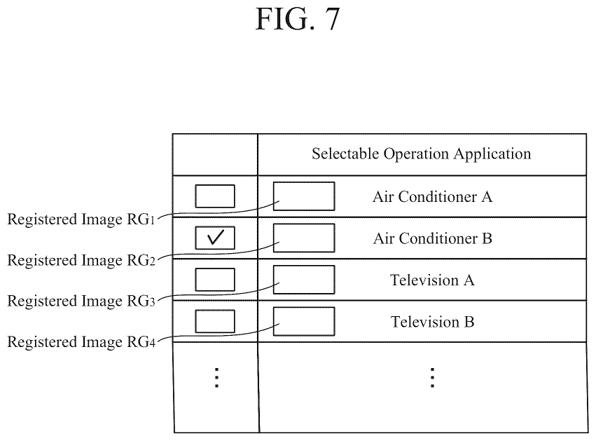

When a user operates the operation target equipment 1, as illustrated in FIG. 7, the operation receiving unit 16 displays one or more operation applications downloaded by the download unit 15 on a display (not illustrated). At this time, the operation receiving unit 16 displays the registered image RGₙ₊₁ (n=1, . . . , N) corresponding to each of the operation applications on the display.

FIG. 7 is an explanatory diagram illustrating a display example of one or more operation applications downloaded by the download unit 15.

In the example of FIG. 7, an operation application of an air conditioner A, an operation application of an air conditioner B, an operation application of a television A, and an operation application of a television B are displayed as the operation applications of the operation target equipment 1.

In addition, in the example of FIG. 7, a registered image RG₁ corresponding to the operation application of the air conditioner A, a registered image RG₂ corresponding to the operation application of the air conditioner A, a registered image RG₃ corresponding to the operation application of the television A, and a registered image RG₄ corresponding to the operation application of the television B are displayed.

The operation receiving unit 16 receives selection of any one operation application from among one or more selectable operation applications (step ST9 in FIG. 4).

In the example of FIG. 7, the operation application of the air conditioner B which is the operation target equipment 1 is selected. A header of the air conditioner B is checked.

The operation receiving unit 16 receives an operation of the operation target equipment 1 by executing the operation application selected by the user (step ST10 in FIG. 4).

In the above first embodiment, the equipment operation device 3 is configured to include: the captured image acquiring unit 11 that acquires, from the camera 2, image data indicating a captured image in which the operation target equipment 1 and a peripheral region of the operation target equipment 1 appear; and the difference detecting unit 12 that performs a process of detecting a difference between the captured image indicated by the image data acquired by the captured image acquiring unit 11 and a registered image that has been recorded. The equipment operation device 3 also includes: the image recording unit 14 that records the captured image as a registered image when the difference is detected by the difference detecting unit 12, acquires a second captured image differentiated from the registered image that has been recorded and records the second captured image as a registered image when the difference is not detected by the difference detecting unit 12; and the download unit 15 that downloads an operation application of the operation target equipment 1 appearing in the registered image recorded by the image recording unit 14. Therefore, the equipment operation device 3 can execute an operation application of operation target equipment appearing in a captured image even in a case where the captured image and a registered image that has been recorded are similar to each other, and a difference between these images is not detected.

In the equipment operation device 3 illustrated in FIG. 1, the captured image acquiring unit 11 acquires image data indicating one captured image PG, and the difference detecting unit 12 performs a process of detecting a difference between the one captured image PG and a registered image RGₙ (n=1, . . . , N) that has been recorded. However, this is merely an example, and the captured image acquiring unit 11 may acquire image data indicating a plurality of captured images PG, and the difference detecting unit 12 may perform a process of detecting a difference between each of the plurality of captured images PG and the registered image RGₙ that has been recorded.

The plurality of captured images PG is, for example, images obtained by capturing images of the same operation target equipment 1 from different directions.

The difference detecting unit 12 performs the process of detecting a difference between each of the plurality of captured images PG and the registered image RGₙ that has been recorded, whereby difference detecting accuracy is improved as compared with a case of performing a process of detecting a difference between one captured image PG and the registered image RGₙ that has been recorded.

In the equipment operation device 3 illustrated in FIG. 1, the captured image acquiring unit 11 acquires image data indicating a captured image in which the operation target equipment 1 and a peripheral region of the operation target equipment 1 appear. For example, in a case where the operation target equipment 1 and a peripheral region thereof are associated with each other before the captured image acquiring unit 11 acquires image data, the captured image acquiring unit 11 may acquire image data indicating a captured image in which only the peripheral region of the operation target equipment 1 appears.

### Second Embodiment

In a second embodiment, an equipment operation device 3 will be described in which when a difference is not detected by a difference detecting unit 12, an image recording unit 17 combines an illustration component indicating an identification marker with operation target equipment 1 appearing in a captured image PG, and thereby acquires an image in which the operation target equipment 1 with the identification marker and a peripheral region thereof appear as a second captured image.

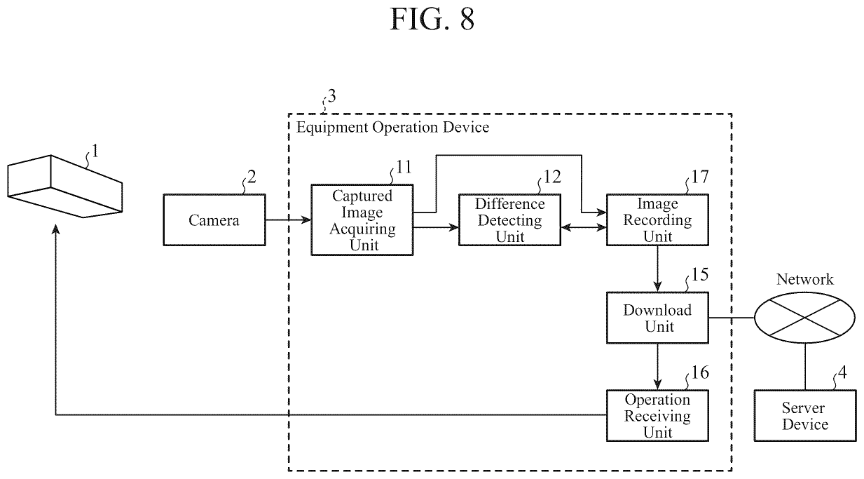

FIG. 8 is a configuration diagram illustrating the equipment operation device 3 according to the second embodiment. In FIG. 8, the same reference numerals as in FIG. 1 indicate the same or corresponding parts, and therefore description thereof is omitted.

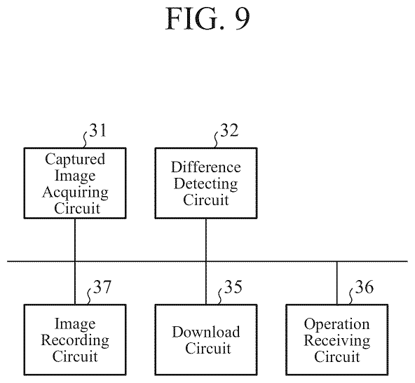

FIG. 9 is a hardware configuration diagram illustrating hardware of the equipment operation device 3 according to the second embodiment. In FIG. 9, the same reference numerals as in FIG. 2 indicate the same or corresponding parts, and therefore description thereof is omitted.

The equipment operation device 3 illustrated in FIG. 8 includes a captured image acquiring unit 11, the difference detecting unit 12, the image recording unit 17, a download unit 15, and an operation receiving unit 16. The equipment operation device 3 illustrated in FIG. 8 does not include a guidance presenting unit 13, unlike the equipment operation device 3 illustrated in FIG. 1.

The image recording unit 17 is implemented by, for example, an image recording circuit 37 illustrated in FIG. 9.

When a difference is detected by the difference detecting unit 12, the image recording unit 17 records the captured image PG as a registered image RGₙ₊₁.

When a difference is not detected by the difference detecting unit 12, the image recording unit 17 combines an illustration component indicating an identification marker with the operation target equipment 1 appearing in the captured image PG, and thereby acquires an image in which the operation target equipment 1 with the identification marker and a peripheral region thereof appear as a second captured image PG′.

The image recording unit 17 records the second captured image PG′ as the registered image RGₙ₊₁.

In FIG. 8, it is assumed that each of the captured image acquiring unit 11, the difference detecting unit 12, the image recording unit 17, the download unit 15, and the operation receiving unit 16, which are constituent elements of the equipment operation device 3, is implemented by dedicated hardware as illustrated in FIG. 9. That is, it is assumed that the equipment operation device 3 is implemented by a captured image acquiring circuit 31, a difference detecting circuit 32, an image recording circuit 37, a download circuit 35, and an operation receiving circuit 36.

To each of the captured image acquiring circuit 31, the difference detecting circuit 32, the image recording circuit 37, the download circuit 35, and the operation receiving circuit 36, for example, a single circuit, a composite circuit, a programmed processor, a parallel programmed processor, an ASIC, an FPGA, or a combination thereof corresponds.

The constituent elements of the equipment operation device 3 are not limited to those implemented by dedicated hardware, and the equipment operation device 3 may be implemented by software, firmware, or a combination of software and firmware.

In a case where the equipment operation device 3 is implemented by software, firmware, or the like, a program for causing a computer to execute processing procedures in each of the captured image acquiring unit 11, the difference detecting unit 12, the image recording unit 17, the download unit 15, and the operation receiving unit 16 is stored in the memory 51 illustrated in FIG. 3. Then, the processor 52 illustrated in FIG. 3 executes the program stored in the memory 51.

FIG. 9 illustrates an example in which each of the constituent elements of the equipment operation device 3 is implemented by dedicated hardware, and FIG. 3 illustrates an example in which the equipment operation device 3 is implemented by software, firmware, or the like. However, this is merely an example, and some of the constituent elements of the equipment operation device 3 may be implemented by dedicated hardware, and the remaining constituent elements may be implemented by software, firmware, or the like.

Next, an operation of the equipment operation device 3 illustrated in FIG. 8 will be described. Note that the equipment operation device 3 is similar to the equipment operation device 3 illustrated in FIG. 1 except for the image recording unit 17. Therefore, only an operation of the image recording unit 17 will be described here.

When a difference is detected by the difference detecting unit 12, the image recording unit 17 records the captured image PG as a registered image RGₙ₊₁ similarly to the image recording unit 14 illustrated in FIG. 1.

When a difference is not detected by the difference detecting unit 12, the image recording unit 17 combines an illustration component indicating an identification marker with the operation target equipment 1 appearing in the captured image PG. The illustration component indicating an identification marker may be stored in an internal memory of the image recording unit 17 or may be given from the outside of the equipment operation device 3. Image processing of combining the illustration component indicating an identification marker with the operation target equipment 1 is a known technique, and therefore a detailed description thereof is omitted.

The image recording unit 17 acquires, as the second captured image PG′, an image in which the operation target equipment 1 with an identification marker and a peripheral region thereof appear, and records the image as the registered image RGₙ₊₁.

In the above second embodiment, the equipment operation device 3 is configured in such a manner that when a difference is not detected by the difference detecting unit 12, the image recording unit 17 combines an illustration component indicating an identification marker with the operation target equipment 1 appearing in a captured image, and thereby acquires an image in which the operation target equipment 1 with the identification marker and a peripheral region thereof appear as a second captured image. Therefore, the equipment operation device 3 can execute an operation application of operation target equipment appearing in a captured image even in a case where a captured image and a registered image that has been recorded are similar to each other, and a difference between these images is not detected, and can omit a user's work of pasting an identification marker to the operation target equipment 1.

### Third Embodiment

In a third embodiment, an equipment operation device 3 including a grid adding unit 18 that adds a grid to a captured image PG or a second captured image PG′ will be described.

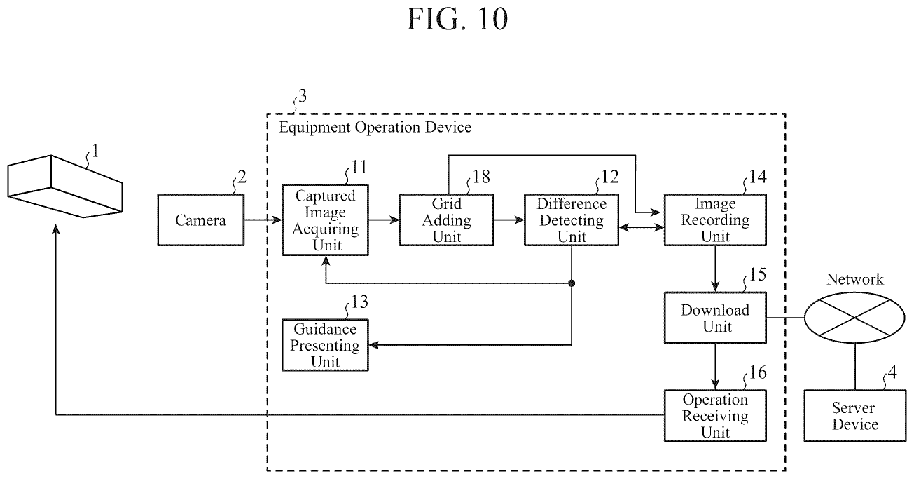

FIG. 10 is a configuration diagram illustrating the equipment operation device 3 according to the third embodiment. In FIG. 10, the same reference numerals as in FIGS. 1 and 8 indicate the same or corresponding parts, and therefore description thereof is omitted.

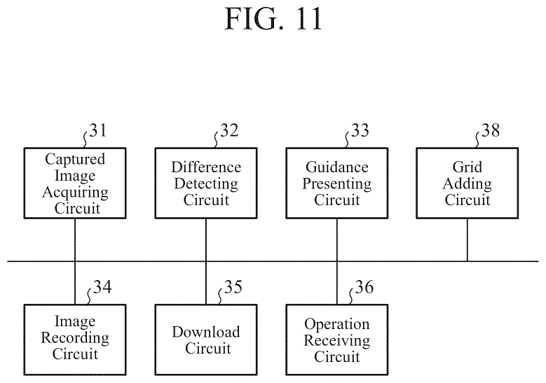

FIG. 11 is a hardware configuration diagram illustrating hardware of the equipment operation device 3 according to the third embodiment. In FIG. 11, the same reference numerals as in FIGS. 2 and 9 indicate the same or corresponding parts, and therefore description thereof is omitted.

The equipment operation device 3 illustrated in FIG. 10 includes a captured image acquiring unit 11, the grid adding unit 18, a difference detecting unit 12, a guidance presenting unit 13, an image recording unit 14, a download unit 15, and an operation receiving unit 16.

The grid adding unit 18 is implemented by, for example, a grid adding circuit 38 illustrated in FIG. 11.

When acquiring image data indicating the captured image PG from the captured image acquiring unit 11, the grid adding unit 18 adds a grid to the captured image PG.

The grid adding unit 18 outputs a captured image PG_{G} with a grid obtained by adding a grid to the captured image PG as the captured image PG to each of the difference detecting unit 12 and the image recording unit 14.

When acquiring image data indicating the second captured image PG′ from the captured image acquiring unit 11, the grid adding unit 18 adds a grid to the second captured image PG′.

The grid adding unit 18 outputs a captured image PG_{G}′ with a grid obtained by adding a grid to the second captured image PG′ as the second captured image PG′ to the image recording unit 14.

In the equipment operation device 3 illustrated in FIG. 10, the grid adding unit 18 is applied to the equipment operation device 3 illustrated in FIG. 1. However, this is merely an example, and the grid adding unit 18 may be applied to the equipment operation device 3 illustrated in FIG. 8.

In FIG. 10, it is assumed that each of the captured image acquiring unit 11, the grid adding unit 18, the difference detecting unit 12, the guidance presenting unit 13, the image recording unit 14, the download unit 15, and the operation receiving unit 16, which are constituent elements of the equipment operation device 3, is implemented by dedicated hardware as illustrated in FIG. 11. That is, it is assumed that the equipment operation device 3 is implemented by a captured image acquiring circuit 31, a grid adding circuit 38, a difference detecting circuit 32, a guidance presenting circuit 33, an image recording circuit 34, a download circuit 35, and an operation receiving circuit 36.

To each of the captured image acquiring circuit 31, the grid adding circuit 38, the difference detecting circuit 32, the guidance presenting circuit 33, the image recording circuit 34, the download circuit 35, and the operation receiving circuit 36, for example, a single circuit, a composite circuit, a programmed processor, a parallel programmed processor, an ASIC, an FPGA, or a combination thereof corresponds.

The constituent elements of the equipment operation device 3 are not limited to those implemented by dedicated hardware, and the equipment operation device 3 may be implemented by software, firmware, or a combination of software and firmware.

In a case where the equipment operation device 3 is implemented by software, firmware, or the like, a program for causing a computer to execute processing procedures in each of the captured image acquiring unit 11, the grid adding unit 18, the difference detecting unit 12, the guidance presenting unit 13, the image recording unit 14, the download unit 15, and the operation receiving unit 16 is stored in the memory 51 illustrated in FIG. 3. Then, the processor 52 illustrated in FIG. 3 executes the program stored in the memory 51.

FIG. 11 illustrates an example in which each of the constituent elements of the equipment operation device 3 is implemented by dedicated hardware, and FIG. 3 illustrates an example in which the equipment operation device 3 is implemented by software, firmware, or the like. However, this is merely an example, and some of the constituent elements of the equipment operation device 3 may be implemented by dedicated hardware, and the remaining constituent elements may be implemented by software, firmware, or the like.

Next, an operation of the equipment operation device 3 illustrated in FIG. 10 will be described. Note that the equipment operation device 3 is similar to the equipment operation device 3 illustrated in FIG. 1 except for the grid adding unit 18. Therefore, here, an operation of the grid adding unit 18 will be mainly described.

When acquiring image data indicating the captured image PG from the captured image acquiring unit 11, the grid adding unit 18 adds a grid to the captured image PG. Since a process itself of adding a grid to the captured image PG is a known technique, detailed description thereof is omitted.

The grid adding unit 18 outputs a captured image PG_{G} with a grid obtained by adding a grid to the captured image PG as the captured image PG to each of the difference detecting unit 12 and the image recording unit 14.

When acquiring image data indicating the second captured image PG′ from the captured image acquiring unit 11, the grid adding unit 18 adds a grid to the second captured image PG′.

The grid adding unit 18 outputs a captured image PG_{G}′ with a grid obtained by adding a grid to the second captured image PG′ as the second captured image PG′ to the image recording unit 14.

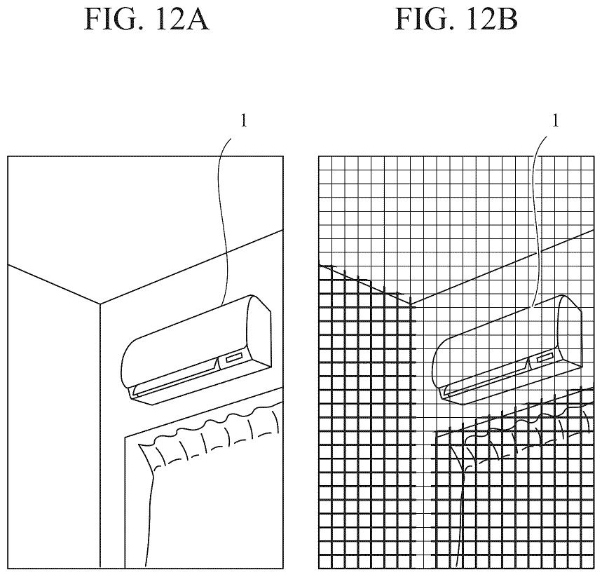

FIG. 12 is an explanatory diagram illustrating an example of the captured image PG_{G} with a grid.

FIG. 12A illustrates an example of the captured image PG without a grid, and FIG. 12B illustrates an example of the captured image PG_{G} with a grid.

In the example of FIG. 12, an interval between a vertical line and a horizontal line constituting a grid is set to ∘∘ mm. As a specific numerical value of ∘∘ mm, for example, 70 mm is used.

By comparing the captured image PG_{G} with a grid with the registered image RGₙ (n=1, . . . , N) that has been recorded, the difference detecting unit 12 detects a difference between the captured image PG_{G} with a grid and the registered image RGₙ that has been recorded. A grid is also added to the registered image RGₙ that has been recorded.

By adding a grid, for example, a size ratio between the operation target equipment 1 and an object present in a peripheral region thereof is clear. Therefore, detection accuracy of a difference between the captured image PG_{G} with a grid and the registered image RG₁ with a grid is higher than detection accuracy of a difference between the captured image PG without a grid and the registered image RGₙ without a grid.

When a difference is detected by the difference detecting unit 12, the image recording unit 14 records the captured image PG_{G} with a grid as a registered image RGₙ₊₁.

When a difference is not detected by the difference detecting unit 12, the image recording unit 14 records the captured image PG_{G}′ with a grid to which an identification marker is pasted as the registered image RGₙ₊₁.

In the above third embodiment, the equipment operation device 3 illustrated in FIG. 10 is configured to include the grid adding unit 18 that adds a grid to a captured image indicated by image data acquired by the captured image acquiring unit 11 and outputs the captured image with a grid to each of the difference detecting unit 12 and the image recording unit 14. Therefore, the equipment operation device 3 illustrated in FIG. 10 can execute an operation application of operation target equipment appearing in a captured image even in a case where the captured image and a registered image that has been recorded are similar to each other, and a difference between these images is not detected, and can improve detection accuracy of the difference between the captured image and the registered image as compared with the equipment operation device 3 illustrated in FIG. 1.

### Fourth Embodiment

In a fourth embodiment, an equipment operation device 3 including a feature region designation receiving unit 19 that receives designation of a feature region that is a region of interest in a captured image PG acquired by a captured image acquiring unit 11 when a difference detecting unit 12 performs a process of detecting a difference between the captured image PG and a registered image RG₁ (n=1, . . . , N) that has been recorded will be described.

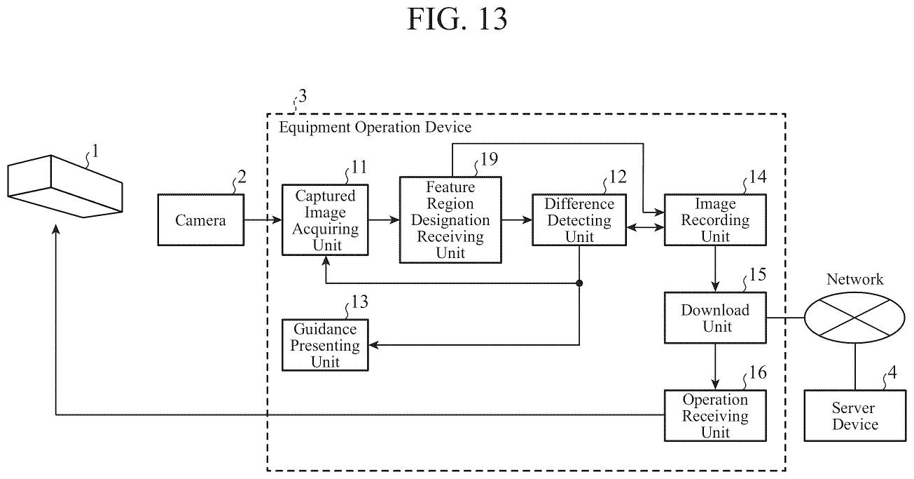

FIG. 13 is a configuration diagram illustrating the equipment operation device 3 according to the fourth embodiment. In FIG. 13, the same reference numerals as in FIGS. 1, 8, and 10 indicate the same or corresponding parts, and therefore description thereof is omitted.

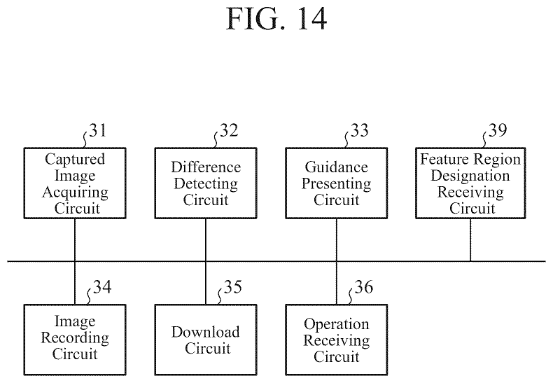

FIG. 14 is a hardware configuration diagram illustrating hardware of the equipment operation device 3 according to the fourth embodiment. In FIG. 14, the same reference numerals as in FIGS. 2, 9, and 11 indicate the same or corresponding parts, and therefore description thereof is omitted.

The equipment operation device 3 illustrated in FIG. 13 includes the captured image acquiring unit 11, the feature region designation receiving unit 19, a difference detecting unit 12, a guidance presenting unit 13, an image recording unit 14, a download unit 15, and an operation receiving unit 16.

The feature region designation receiving unit 19 is implemented by, for example, a feature region designation receiving circuit 39 illustrated in FIG. 14.

The feature region designation receiving unit 19 receives designation of a feature region FRₘ that is a region of interest in a captured image PG acquired by the captured image acquiring unit 11 when the difference detecting unit 12 performs a process of detecting a difference between the captured image PG and a registered image RG₁ (n=1, . . . , N) that has been recorded. m=1, . . . , M, and M is an integer equal to or more than 1.

The feature region designation receiving unit 19 outputs a captured image PG_{F} in which the feature region FRₘ is designated to each of the difference detecting unit 12 and the image recording unit 14 as the captured image PG.

The feature region designation receiving unit 19 outputs a captured image PG_{F}′ in which the feature region FRₘ is designated to the image recording unit 14 as a second captured image PG′.

In addition, when receiving designation of the plurality of feature regions FRₘ, the feature region designation receiving unit 19 receives designation of a priority order of each of the feature regions FRₘ.

The feature region designation receiving unit 19 outputs the captured image PG_{F} in which the feature region FRₘ with a priority order is designated to each of the difference detecting unit 12 and the image recording unit 14 as the captured image PG.

The feature region designation receiving unit 19 outputs the captured image PG_{F}′ in which the feature region FRₘ with a priority order is designated to the image recording unit 14 as the second captured image PG′.

In the equipment operation device 3 illustrated in FIG. 13, the feature region designation receiving unit 19 is applied to the equipment operation device 3 illustrated in FIG. 1. However, this is merely an example, and the feature region designation receiving unit 19 may be applied to the equipment operation device 3 illustrated in FIG. 8 or the equipment operation device 3 illustrated in FIG. 10.

In FIG. 13, it is assumed that each of the captured image acquiring unit 11, the feature region designation receiving unit 19, the difference detecting unit 12, the guidance presenting unit 13, the image recording unit 14, the download unit 15, and the operation receiving unit 16, which are constituent elements of the equipment operation device 3, is implemented by dedicated hardware as illustrated in FIG. 14. That is, it is assumed that the equipment operation device 3 is implemented by a captured image acquiring circuit 31, a feature region designation receiving circuit 39, a difference detecting circuit 32, a guidance presenting circuit 33, an image recording circuit 34, a download circuit 35, and an operation receiving circuit 36.

To each of the captured image acquiring circuit 31, the feature region designation receiving circuit 39, the difference detecting circuit 32, the guidance presenting circuit 33, the image recording circuit 34, the download circuit 35, and the operation receiving circuit 36, for example, a single circuit, a composite circuit, a programmed processor, a parallel programmed processor, an ASIC, an FPGA, or a combination thereof corresponds.

The constituent elements of the equipment operation device 3 are not limited to those implemented by dedicated hardware, and the equipment operation device 3 may be implemented by software, firmware, or a combination of software and firmware.

In a case where the equipment operation device 3 is implemented by software, firmware, or the like, a program for causing a computer to execute processing procedures in each of the captured image acquiring unit 11, the feature region designation receiving unit 19, the difference detecting unit 12, the guidance presenting unit 13, the image recording unit 14, the download unit 15, and the operation receiving unit 16 is stored in the memory 51 illustrated in FIG. 3. Then, the processor 52 illustrated in FIG. 3 executes the program stored in the memory 51.

FIG. 14 illustrates an example in which each of the constituent elements of the equipment operation device 3 is implemented by dedicated hardware, and FIG. 3 illustrates an example in which the equipment operation device 3 is implemented by software, firmware, or the like. However, this is merely an example, and some of the constituent elements of the equipment operation device 3 may be implemented by dedicated hardware, and the remaining constituent elements may be implemented by software, firmware, or the like.

Next, an operation of the equipment operation device 3 illustrated in FIG. 13 will be described. Note that the equipment operation device 3 is similar to the equipment operation device 3 illustrated in FIG. 1 except for the feature region designation receiving unit 19. Therefore, here, an operation of the feature region designation receiving unit 19 will be mainly described.

The feature region designation receiving unit 19 receives designation of a feature region FRₘ (m=1, . . . , M) that is a region of interest when the difference detecting unit 12 performs a process of detecting a difference between the captured image PG and a registered image RGₙ (n=1, . . . , N) that has been recorded. Since a process itself of receiving the feature region FRₘ designated by a user is a known technique, detailed description thereof is omitted.

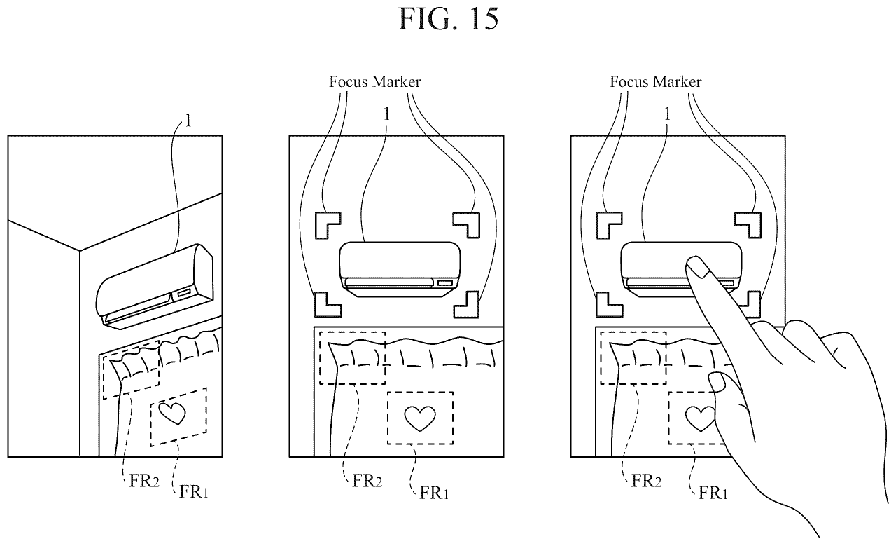

FIG. 15 is an explanatory diagram illustrating an example of the feature region FRₘ.

In the example of FIG. 15, a region FR₁ in which a heart-shaped mark is applied to a curtain and a region FR₂ at a left corner of the curtain are designated as the feature regions FRₘ.

In addition, when receiving designation of the plurality of feature regions FRₘ, the feature region designation receiving unit 19 receives designation of a priority order of each of the feature regions FRₘ. Since a process itself of receiving a priority order designated by a user is a known technique, detailed description thereof is omitted.

In the example of FIG. 15, since the feature region FR₁ and the feature region FR₂ are designated, the feature region designation receiving unit 19 receives designation of priority orders of the feature region FR₁ and the feature region FR₂.

Here, for convenience of description, it is assumed that the feature region FR₁ has a first priority order and the feature region FR₂ has a second priority order.

The feature region designation receiving unit 19 outputs the captured image PG_{F} in which the feature region FRₘ with a priority order is designated to each of the difference detecting unit 12 and the image recording unit 14 as the captured image PG.

The feature region designation receiving unit 19 outputs the captured image PG_{F}′ in which the feature region FRₘ with a priority order is designated to the image recording unit 14 as the second captured image PG′.

The difference detecting unit 12 acquires the captured image PG in which the feature region FRₘ with a priority order is designated from the feature region designation receiving unit 19.

By comparing the feature region FR₁ having the first priority order in the captured image PG_{F} with a region corresponding to the feature region FR₁ in the registered image RGₙ (n=1, . . . , N) that has been recorded, the difference detecting unit 12 detects a difference between the feature region FR₁ and the region corresponding to the feature region FR₁.

When there is a difference between the feature region FR₁ and the region corresponding to the feature region FR₁, the difference detecting unit 12 ends the comparing process.

When there is no difference between the feature region FR₁ and the region corresponding to the feature region FR₁, by comparing the feature region FR₂ having the second priority order with a region corresponding to the feature region FR₂ in the registered image RGₙ that has been recorded, the difference detecting unit 12 detects a difference between the feature region FR₂ and the region corresponding to the feature region FR₂.

When a difference is detected by the difference detecting unit 12, the image recording unit 14 acquires the captured image PG_{F} in which the feature region FRₘ is designated as the captured image PG and records the captured image PG_{F} as the registered image RGₙ₊₁.

When a difference is not detected by the difference detecting unit 12, the image recording unit 14 acquires the captured image PG_{F}′ in which the feature region FRₘ with a priority order is designated as the second captured image PG′, and records the captured image PG_{F}′ as the registered image RGₙ₊₁.

In the above fourth embodiment, the equipment operation device 3 illustrated in FIG. 13 is configured to include the feature region designation receiving unit 19 that receives designation of a feature region that is a region of interest in a captured image acquired by the captured image acquiring unit 11 when the difference detecting unit 12 performs a process of detecting a difference between the captured image and a registered image that has been recorded, and outputs a captured image in which a feature region with a priority order is designated to each of the difference detecting unit 12 and the image recording unit 14. Therefore, the equipment operation device 3 illustrated in FIG. 13 can execute an operation application of operation target equipment appearing in a captured image even in a case where the captured image and a registered image that has been recorded are similar to each other, and a difference between these images is not detected, and can reduce a processing load of the difference detecting process in the difference detecting unit 12 as compared with the equipment operation device 3 illustrated in FIG. 1.

Note that the present disclosure can freely combine the embodiments to each other, modify any constituent element in each of the embodiments, or omit any constituent element in each of the embodiments.

### INDUSTRIAL APPLICABILITY

The present disclosure is suitable for an equipment operation device and an equipment operation method.

### REFERENCE SIGNS LIST

1: operation target equipment, 2: camera, 3: equipment operation device, 4: server device, 11: captured image acquiring unit, 12: difference detecting unit, 13: guidance presenting unit, 14: image recording unit, 15: download unit, 16: operation receiving unit, 17: image recording unit, 18: grid adding unit, 19: feature region designation receiving unit, 31: captured image acquiring circuit, 32: difference detecting circuit, 33: guidance presenting circuit, 34: image recording circuit, 35: download circuit, 36: operation receiving circuit, 37: image recording circuit, 38: grid adding circuit, 39: feature region designation receiving circuit, 51: memory, 52: processor

1. An equipment operation device comprising:
processing circuitry configured to
acquire, from a camera, image data indicating a captured image in which operation target equipment and a peripheral region of the operation target equipment appear;
perform a process of detecting a difference between the captured image indicated by the acquired image data and a first registered image that has been recorded;
record the captured image as a second registered image that is different from the first registered image when the difference is detected, and acquire a second captured image differentiated from the first registered image that has been recorded and to record the second captured image as the second registered image that is different from the first registered image when the difference is not detected; and
download an operation application of the operation target equipment appearing in the second registered image having been recorded.

2. The equipment operation device according to claim 1, wherein
the processing circuitry acquires, from the camera, image data indicating a captured image in which the operation target equipment with an identification marker and the peripheral region appear as the second captured image.

3. The equipment operation device according to claim 2,
wherein the processing circuitry is further configured to
present guidance to prompt a user to paste the identification marker when the difference is not detected;
acquire image data indicating a captured image in which the operation target equipment to which the identification marker is pasted and the peripheral region appear from the camera after the guidance is presented; and
acquire, as the image data indicating the second captured image, the acquired image data after the guidance is presented.

4. The equipment operation device according to claim 1, wherein
the processing circuitry is further configured to combine an illustration component indicating an identification marker with the operation target equipment appearing in the captured image indicated by image data having been acquired, and acquire an image in which the operation target equipment with the identification marker and the peripheral region appear as the second captured image.

5. The equipment operation device according to claim 1,
wherein the processing circuitry is further configured to receive selection of any one operation application from among one or more operation applications having been downloaded and execute the selected operation application.

6. The equipment operation device according to claim 1,
wherein the processing circuitry is further configured to add a grid to the captured image indicated by the acquired image data and output the captured image with the grid.

7. The equipment operation device according to claim 1,
wherein the processing circuitry is further configured to receive designation of a feature region that is a region of interest in the captured image indicated by the image data having been acquired when the processing circuitry performs the process of detecting the difference between the captured image indicated by the acquired image and the first registered image that has been recorded, and to output a captured image in which the feature region is designated.

8. The equipment operation device according to claim 7, wherein
when receiving designation of a plurality of feature regions, the processing circuitry receives designation of a priority order of each of the feature regions, and outputs a captured image in which the feature region with the priority order is designated.

9. An equipment operation method comprising:
acquiring from a camera, image data indicating a captured image in which operation target equipment and a peripheral region of the operation target equipment appear;
performing a process of detecting a difference between the captured image indicated by the acquired image data and a first registered image that has been recorded;
recording the captured image as a second registered image that is different from the first registered image when the difference is detected, and acquiring a second captured image differentiated from the first registered image that has been recorded, and recording the second captured image as the second registered image that is different from the first registered image when the difference is not detected; and
downloading an operation application of the operation target equipment appearing in the second registered image having been recorded.
